(19) United States
(12) Patent Application Publication
(10) Pub. No.: US 2022/0286153 A1
(43) Pub. Date: Sep. 8, 2022

(54) APPARATUS FOR PROCESSING PASSIVE INTERMODULATION PRODUCTS

(71) Applicant: NOKIA SOLUTIONS AND NETWORKS OY, Espoo (FI)

(72) Inventors: Marko FLEISCHER, Unterhaching (DE); Helmut HEINZ, Türkheim (DE); Jakub JUCHNIEWICZ, Ulm (DE); Rene RÖSCHKE, Mammendorf (DE); Jan HELLMANN, Munich (DE)

(21) Appl. No.: 17/760,624

(22) PCT Filed: Sep. 17, 2019
(86) PCT No.: PCT/EP2019/074817

§ 371 Date: Mar. 15, 2022

(51) Int. Cl. H04B 1/10; H04B 1/00

(52) U.S. Cl. CPC H04B 1/1027; H04B 1/0053

(57) ABSTRACT

The present subject matter relates to an apparatus for a communication system. The communication system comprises transmitters being configured to operate in multiple transmission frequency bands. The apparatus comprises means being configured for: capturing a set of over-the-air signals at distinct frequency bands of the multiple transmission frequency bands; aligning in time the set of signals using delays between the set of signals and a received signal at a selected receiver of the communication system; combining the set of aligned signals to generate a composite signal; and estimating an interference signal that is caused by the set of signals at the selected receiver by weighting the composite signal using a set of one or more calibrated parameters for the estimation.

### FIELD OF THE INVENTION

Various example embodiments relate to computer networking, and more particularly to a method for processing of passive intermodulation products.

### BACKGROUND

Intermodulation products may be generated in a wireless system when two or more signals at different frequencies are transmitted along a signal path including a component having a non-linear transmission characteristic; these products differ in frequency from the signals from which they were generated, and may potentially cause interference to other signals.

### SUMMARY

Example embodiments provide an apparatus for a communication system. The communication system comprises transmitters being configured to operate in multiple transmission frequency bands. The apparatus comprises means configured for: capturing a set of over-the-air signals at distinct frequency bands of the multiple transmission frequency bands, aligning in time the set of signals using delays between the set of signals and a received signal at a selected receiver of the communication system, combining the set of aligned signals to generate a composite signal, estimating an interference signal that is caused by the set of signals at the selected receiver by weighting the composite signal using a set of one or more calibrated parameters for the estimation.

According to further example embodiments, a method for a communication system comprises: capturing a set of over-the-air signals at distinct transmission frequency bands of the communication system, aligning in time the set of signals using delays between the set of signals and a received signal at a selected receiver of the communication system, combining the set of aligned signals to generate a composite signal, estimating an interference signal that is caused by the set of signals at the selected receiver by weighting the composite signal using a set of one or more calibrated parameters.

According to further example embodiments, a computer program comprises instructions stored thereon for performing at least the following: capturing a set of over-the-air signals at distinct transmission frequency bands of the communication system, aligning in time the set of signals using delays between the set of signals and a received signal at a selected receiver of the communication system, combining the set of aligned signals to generate a composite signal, estimating an interference signal that is caused by the set of signals at the selected receiver by weighting the composite signal using a set of one or more calibrated parameters.

According to further example embodiments, a system comprises transmitters, at least one receiver and an apparatus. The transmitters are configured to operate in multiple transmission frequency bands. The apparatus is configured for: capturing a set of over-the-air signals at distinct frequency bands of the multiple transmission frequency bands, aligning in time the set of signals using delays between the set of signals and a received signal at the receiver, combining the set of aligned signals to generate a composite signal, estimating an interference signal that is caused by the set of signals at the receiver by weighting the composite signal using a set of one or more calibrated parameters for the estimation.

### BRIEF DESCRIPTION OF THE DRAWINGS

The accompanying figures are included to provide a further understanding of examples, and are incorporated in and constitute part of this specification. In the figures:

FIG. 1 depicts a diagram of a communication system;

FIG. 2 depicts a diagram of a communication system in accordance with an example of the present subject matter;

FIG. 3 depicts a block diagram of an apparatus in accordance with an example of the present subject matter;

FIG. 4 depicts a block diagram of an apparatus in accordance with an example of the present subject matter;

FIG. 5 is a flowchart of a method for estimating a passive intermodulation (PIM) correction signal in accordance with an example of the present subject matter;

FIG. 6 is a flowchart of a method for estimating a PIM correction signal for different receivers in accordance with an example of the present subject matter;

FIG. 7 is a flowchart of a method for estimating a PIM correction signal for different PIM sources in accordance with an example of the present subject matter;

FIG. 8 is a flowchart of a method for obtaining optimal values of the calibrated parameters;

FIG. 9 is a block diagram of a calibration setup for estimating calibration values of the calibrated parameters.

FIG. 10 is a block diagram showing an example of an apparatus according to an example of the present subject matter.

### DETAILED DESCRIPTION

In the following description, for purposes of explanation and not limitation, specific details are set forth such as particular architectures, interfaces, techniques, etc., in order to provide a thorough understanding of the examples. However, it will be apparent to those skilled in the art that the disclosed subject matter may be practiced in other illustrative examples that depart from these specific details. In some instances, detailed descriptions of well-known devices and/or methods are omitted so as not to obscure the description with unnecessary detail.

A PIM signal or interference signal may be modeled as function of the composite signal, wherein the calibrated set of parameters are parameters of the model. The weighting of the composite signal using the calibrated set of parameters is performed in accordance with the model e.g. the weighting of the composite signal comprises applying the model on the composite signal in order to estimate the interference signal. The model may for example comprise a non-linear model in that its application to the composite signal may result in a non-linear transformation of the composite signal e.g. the model defines the interference signal as a nonlinear combination the composite signal and the calibrated parameters.

For example, the set of calibrated parameters are PIM model parameters (of a PIM model) whose set of values are the result of a calibration of the apparatus during a calibration process (or calibration step). The PIM model may model the interference signal as a function of the composite signal. The PIM model may for example involve or result in a non-linear transformation of the composite signal. The calibration of the apparatus may be performed by iteratively changing values of the PIM model parameters, estimating the PIM signal using the current values and checking the accuracy of the estimated PIM signal for each iteration. For example, in each current iteration, the value of each parameter of the PIM models parameters may be changed resulting in a set of current values of the PIM model parameters. The accuracy of the estimated PIM signal using that set of current values may be checked e.g. a user may be prompted to provide a feedback indicating if the PIM signal fulfills an accuracy criterion or the accuracy criterion may automatically be checked. E.g. the accuracy criterion my require to obtain an optimal value of a predefined objective function. If the estimated PIM signal fulfills the accuracy criterion (e.g. the user provides a positive feedback or it is automatically determined that the estimated PIM signal is accurate), then the set of current values may be the values of the calibrated set of parameters.

In one example, the calibration of the apparatus may also calibrate the values of the delays used for performing the aligning step. That is, in each iteration not only the values of the PIM model parameters are changed but also the delays of the signals. For that, for each frequency band of the transmission frequency bands a delay is provided. That is, the signals that belong to a same frequency band may have a same delay value. In each iteration, it is checked if the accuracy of the PIM estimation using current values of the PIM parameters and delays fulfils the accuracy criterion, and if so the set of current values of the PIM model parameters and current values of the delays may be the values to be used for performing the weighting and the aligning steps respectively e.g. during a run time of the communication system.

In another example, the calibrated parameters may be empirical parameters e.g. the composite signal may be weighted in accordance with a user defined function. For example, the user defined function may define the interference signal as function of the composite signal e.g. the user defined function may involve a non-linear transformation using the calibrated parameters. The values of the calibrated parameters may be tuned in the calibration process so that the transformed composite signal represents the interference signal. The weighting of the composite signal comprises applying the user defined function on the composite signal.

Each received signal of the set of signals is (or is part of) a stream having frequencies belonging to a respective same frequency band. The set of signals represent a respective set of streams, each stream having a respective distinct frequency band.

By receiving and processing over-the-air signals, an apparatus may have access to transmitter (TX) data in a format that represents the data as it is transmitted. For example, the data to be transmitted by a transmitter may be pre-processed at the transmitter before being transmitted. The pre-processing may for example comprise a crest factor reduction (CFR), digital predistortion and duplex filtering which happen inside a radio. The present subject matter may enable to access data as being pre-processed at the transmitters. This may guaranty that the estimated interference signal contains all TX radio frequency (RF) impairments and meets the incoming receiver (RX) noise. This may enable to accurately correct the received signals.

The interference signal may be a passive intermodulation (PIM) correction signal. The present subject matter may enable an accurate estimation of PIM correction signals such as air induced multisector/multiband PIM signals. The present subject matter may enable a flexible choice of frequencies in a wireless system regardless of the presence of intermodulation frequencies. This may particularly be advantageous with the increasing requirements for bandwidth, output power and the coexistence of multiple radio standards such as 2G, 3G, 4G and 5G.

The present subject matter may not be frequency band limited as it can be configured to access data at different frequency bands of different transmitters. This may enable to implement the apparatus for different sites as well as for single sites. A site may refer to the area covered by a base station, e.g. eNode-B, of the communication system.

The apparatus may be referred to as a PIM antenna network. The present subject matter may enable a PIM antenna network for MIMO deployments in frequency division duplex (FDD) systems.

The apparatus may be configured to access received signals at receivers of the communication system. The receivers of the communication system comprise the selected receiver. For example, the apparatus may be configured to receive the received signal at the selected receiver in order to perform the time aligning.

The selected receiver of the communication system may be any receiver of the communication system that may be affected by PIM signals. For example, the selected receiver may be a user selected receiver. That is, the apparatus may receive information indicating the selected receiver. In another example, the apparatus may automatically (e.g. randomly) select the receiver among other receivers of the communication system. In another example, the apparatus may be configured to repeat the aligning, combining and estimating of the PIM signal for respective receivers of the communication system and e.g. mitigate the PIM effect by correcting in parallel received signals in the receivers. A different receiver of the receivers may be selected, in each iteration, until all receivers are processed e.g. the selected receiver may be a receiver of the receivers that is selected in one iteration.

The interference signal is the weighted composite signal. The weighted composite signal results from the weighting of the composite signal using the set of one or more calibrated parameters.

The apparatus may be calibrated so that it can estimate the interference signal. The calibration of the apparatus may enable to compare measurement/estimation values of the interference signal delivered by the apparatus with those of a known air induced PIM signal. The apparatus may for example be calibrated on site where it is being used. For example, if the apparatus is configured to operate as part of an antenna system of the communication system, the calibration may be performed in accordance with a system configuration of the communication system. This may enable to regularly update, on site, the values of the calibrated parameters. The regular update may be advantageous as PIM conditions may change over time. In addition or alternatively to determining the calibrated parameters, the delays may be adjusted as well during the calibration process.

According to an example, the means comprises receiving means for performing the capturing, the receiving means comprising an antenna system being configured to be polarized in accordance with polarizations of the transmitters.

For example, in some of the sites, the antenna system may contain horizontally polarized antennas while for remaining sites, the antenna system may contain vertically polarized antennas. Alternatively, for each site, the antenna system may contain both horizontally and vertically polarized antennas.

Using an antenna system with the same polarization complexity as the transmitters may avoid a mismatch between the antenna system and transmitter polarizations which eventually could block the reception in the receiving means. This example may thus take advantage of the polarization diversity of the transmitters to increase the PIM signal estimation accuracy by receiving as much transmitted signals as possible.

According to an example, the antenna system comprises a first antenna being polarized in accordance with a first polarization direction for capturing a subset of signals of the set of signals having the first polarization direction, and a second antenna being polarized in accordance with a second polarization direction for capturing a subset of signals of the set of signals having the second polarization direction.

The first and second antennas may be two cross polarized antennas. For example, the antennas can be either vertically or horizontally polarized or mixed. Using multiple antennas may increase the sensitivity and range of the apparatus. The different antenna streams of the first and second antennas are processed in accordance with the present subject matter to determine the composite signal for each antenna stream and the composite signals are input to a common nonlinear model in order to estimate the interference signal.

In case of a MIMO system, complex MIMO streams are realized with orthogonal polarized antennas. To guarantee a proper reception of all TX signals with the antenna system, the used antenna(s) of the antenna system may have a same polarization. The complexity of the antenna system does not depend on the number of MIMO streams but only on the number of polarization complexities in the transmitters. For example, a 128×128 MIMO system with typical cross polarized antennas may need only two cross polarized antennas in the antenna system instead of 128″2=16384 radio feedbacks.

The antenna system may for example be integrated in a MIMO antenna system as two additional antennas with appropriate polarization. In another example, the antenna system may be provided as a standalone solution. It may be irrelevant if the antenna system is in the near or far field for a common MIMO TX data stream reception. The receiver associated with the antenna system does not need to be sensitive as a standard receiver since the antenna system is closed to the transmitter. Saturation effects may be avoided by the present subject matter.

According to an example, the receiving means comprises a receiver per antenna of the antenna system. Instead of having a single receiver for all antennas, this example may enable a distributed processing of signals which may increase the time processing efficiency of the received signals. This may enable to further improve the PIM signal estimation process in accordance with the present subject matter.

According to an example, the set of signals comprises inter-band and intra-band signals. The apparatus may be configured for determining one same delay for intra-band signals of a same frequency band. The intra-band signals may for example be received from MIMO transmitters associated with a single antenna. The intra-band signals of a same frequency band are received as a single stream e.g. s1(t). This may save resources that would otherwise be required for computing a delay for each signal of the intra-band signals, while still enabling an accurate PIM signal estimation.

According to an example, the means are configured for performing a cross correlation of each signal of the set of signals with the received signal; and determining the delays using results of the cross correlation.

Each individual signal of the set of signals may be correlated with the received signal to produce correlation data representing a correlation for each individual signal. The correlation may for example be a cross correlation. The correlation data may be used to define the delays. The cross-correlation may reach its maximum when the two correlated signals considered become most similar to each other. The delay may for example be determined using the maximum value in the correlation data.

The correlation may be obtained by a cross-correlation function (xcorr) that has two arguments, wherein one of the arguments is the received signal Rx and the other argument can be a signal Tx or a particular order IM product. For example, the correlation may be obtained as a xcorr(abs(TX),abs(RX)) correlation or as a IM3 harmonic correlation xcorr(IM3(TX1, TX2),RX), where abs(X) returns the absolute value of each element in array X. The result of the xcorr function is a vector. The delay of the signal may be obtained using the maximum value of the vector.

According to an example, the cross correlation is performed between absolute values of the signal and absolute values of the received signal. This may enable to compare the envelope in time domain between the correlated signals. The cross-correlation function determines the cross-correlation between a pair of signals (or a pair of discrete-time sequences) such as abs(TX) and abs(RX). Using absolute values may further increase the aligning accuracy of the present subject matter. The absolute values enable to obtain the direct delay relationship between the individual signal TX and received signal RX.

According to an example, the means are further configured for: further aligning in time the set of signals using further delays of the set of signals to the selected receiver; combining the further aligned set of signals to generate a further composite signal; weighting the further composite signal using another set of one or more calibrated parameters, thereby estimating another interference signal that is caused by the set of signals at the selected receiver, the other interference signal having a frequency different from a frequency of the interference signal. This may enable to correct another receive RX channel.

This example may enable to further improve the PIM signals estimation by taking into account multiple sources of PIM. This example enables to estimate air induced PIM signals from two different PIM sources. The source of PIMs as being considered by the present subject matter may be sources that create air-induced PIMs e.g. the source of PIMs are outside a transceiver system of the communication system so that the transmitted over-the-air signals hit or impinge upon the sources of PIM. In another example, the sources of PIM may also include a conducted PIM source that is inside the transceiver system, wherein the conducted PIM source affects equally all transmitted signals of a same frequency band.

According to an example, the means are configured for performing a cross correlation of each signal of the set of signals with a received signal at the selected receiver; and determining the delay of the signal using a maximum value of the resulting cross correlation and determining the other delay of the signal using a second maximum value of the resulting cross correlation.

For example, for a given signal S1 of the set of signals, the correlation data may be determined by performing a cross correlation with the received signal Rx. The correlation data may comprise a first, second etc maximum values. The delay of S1 may for example be determined using the first maximum value and the further delay of S1 may be determined using the second maximum value.

According to an example, the calibrated parameters are parameters of a passive intermodulation, PIM, model. The means further comprises an estimation circuitry configured for determining, during a calibration step, values of the calibrated parameters in accordance with a system configuration of the communication system. The determining comprises comparing estimated interference signals with calibration interference signals.

For example, a PIM model, for an IM3 location, taking into account the IM3 and IM5 products may be defined as follows:

b3*ts(n).*(ts(n).*conj(ts(n)))+b5*ts(n).*(ts(n).*conj(ts(n)))\hat{ }2, where n is time and ts is the composite signal. In this case, b3 and b5 are the calibrated parameters. The signal ts(n) is weighted by b3*(ts(n).*conj(ts(n))) and by b5*(ts(n).*conj(ts(n)))\hat{ }2. In another example, the PIM model for an IM3 location using the IM3 product only with different delays may be defined as follows: b3*ts(n).*(ts(n).*conj(ts(n)))+b13*ts(n).*(ts(n−1).*conj(ts(n−1)))+b23*ts(n).*(ts(n).conj(ts(n)))+b33*ts(n+1).*(ts(n+1).*conj(ts(n+1))). In this case, b3 and b13, b23 and b33 are the calibrated parameters which may be referred to as a model memory.

According to an example, the system configuration indicates at least one or more sources of a passive intermodulation, PIM.

The system configuration is descriptive of the communication system. The communication system may comprise the apparatus. For example, the system configuration may define the number of transmitters, the placements of the transmitters, the receiver and the source(s) of PIMs etc. For example, the same system configuration of the communication system may be used to perform the calibration process in order to obtain the calibrated parameters (e.g. in a real-time system or in a calibration setup).

According to an example, the means further comprise a subtraction circuitry configured to correct a received signal at the selected receiver by using the interference signal.

The parallel operation of the selected receiver and the transmitters of the communication system may cause interferences which may limit in particular the sensitivity on the receiver. For example, when considering e.g. a high-power broadband multi-standard multicarrier FDD system, it is possible that the system performance and sensitivity is affected by transmitter induced intermodulation products falling into the receive band, e.g. at RX channels. This example may mitigate the distortion effect that affects received signals at the receiver.

According to an example, the subtraction circuitry is configured to correct the signal by a subtraction processing of the interference signal from the received signal being.

For example, the present subject matter may save resources that would otherwise be required by a cancellation approach. The cancellation approach which is based on an individual base band TX carrier may require at least a cumbersome resampling up/down conversion, filtering and frequency shifting approach. The cancellation approach is used as TX data are available only in ideal form without any TX RF impairments like CFR artefacts which limits the cancellation gain further.

According to an example, the apparatus is (or is part of) a frequency division duplex base transceiver station.

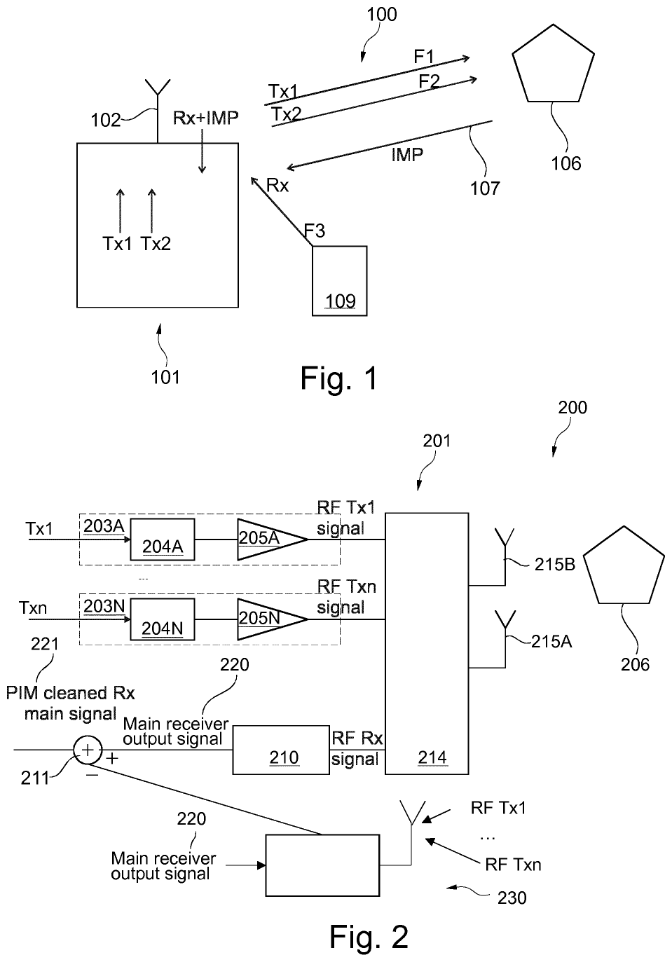

FIG. 1 depicts a diagram of a communication system 100. The communication system 100 comprises a transceiver system 101. The transceiver system 101 may be a base station for a cellular communication network, but is not limited thereto. The transceiver system 101 may, for example, be a multi-carrier or multi-band system (e.g., a system that simultaneously operates in at least two different transmission frequency bands or at least two carriers in the same frequency band).

The transceiver system 101 is configured to send a set of signals via an antenna 102. For simplification of the description, only one antenna is shown but it is not limited to. Although only a set of two signals Tx1 and Tx2 is illustrated for this particular example, it should be appreciated that the set of signals may comprise more than two signals.

The set of signals Tx1 and Tx2 are transmitted at frequencies F1 and F2 respectively. However, intermodulation products may be generated when the set of signals Tx1 and Tx2 are transmitted along a signal path including a source of PIM. The sources of PIM may be outside the transceiver system triggering an air induced PIM. In another example, the sources of PIM may further include a source that is inside the transceiver system inducing a conducted PIM affecting equally all signals of a same frequency band. The air induced PIM may be caused by sources of PIM at predefined distances to the transceiver system 101. For example, in case of a transceiver system of a MIMO installation with several transmit signals, the transmit signals on the same frequency may cause higher power spectrum densities and thus metallic objects in a 10 m distance or more from the transceiver system 101 are not negligible and can cause uplink (UL) desensitization and throughput losses.

In the example shown in FIG. 1, the set of signals Tx1 and Tx2 impinge upon a source of PIM 106. The source of PIM 106 may, for example, be a metallic component comprising a ferromagnetic material. IM products 107 of the set of signals Tx1 and Tx2 are generated due to the non-linear response of the source of PIM 106.

The set of signals Tx1 and Tx2 may produce, for example, third order IM products at frequencies 2F1-F2 and 2F2-F1, fifth order IM products at frequencies 3F1-2F2 and 3F2-2F1 and other products. This provides relationships between signal frequencies, e.g. F1 and F2, and the frequencies of IM products produced from those frequencies. FIG. 1 shows that IM products 107 of the set of signals Tx1 and Tx2 are transmitted from the source of PIM 106. The transmission of the IM products 107 may be performed at a respective frequency of the IM products 107.

The IM products 107 fall at least in part, within a received channel at frequency F3 and appear as interference to a received signal Rx that is transmitted at radio frequency from, for example, a user equipment 109 in communication with the transceiver system 101.

FIG. 2 depicts a diagram of a communication system 200 in accordance with an example of the present subject matter. The communication system may for example be a MIMO radio system. The communication system comprises a transceiver system 201. The transceiver system 201 includes multiple transmitters 203A-N and at least one receiver 210 (also referred to herein as main receiver) coupled to at least two antennas 215A-B. For example, each subset of transmitters 203A-N may be coupled to a respective antenna 215A-B. Each subset of transmitters may be configured to transmit data in a respective transmission frequency band (referred to as TX band). The TX bands may for example comprise long term evolution (LTE) bands 14, 17 and 29. By isolating each data stream of the transmitters 203A-N quality problems may be mitigated. The transmitters 203A-N and the receiver 210 may be coupled to antennas 215A-B via a duplexer 214. The signals captured by the antennas 215A-B may be received at the receiver 210 of the transceiver system 201. In another example, each antenna 215A-B may be associated with respective receiver, resulting in the transceiver system 201 having two receivers.

The communication system 200 may use multiple types of antenna polarization schemes to improve diversity. For that, each antenna of the antennas 215A-B may have a specific polarization type, which is determined by its design and represents the oscillation direction of the electromagnetic radio waves as they propagate from the antenna's radiating element. For example, the polarization type may be a linear polarization type or elliptical polarization type. The linear polarization occurs in a straight line, and can be vertical, horizontal, or at any angle. The electrical wave of the antenna's signal oscillates up and down along the axis of this straight line.

FIG. 2 shows only one transceiver system but it is not limited to. For example, the communication system 200 may comprise multiple transceiver systems such as the transceiver system 201.

Each of the transmitters 203A-N includes a digital-to-analog (D/A) converter 204A-N and a power amplifier (PA) 205A-N connected as shown. Each of the transmitters 203A-N operates to process a respective digital input signal Tx1-Txn, which may for example be a digital baseband signal, to output a radio frequency transmit signal. The processing of the digital input signal may for example comprise a CFR and digital predistortion processing. The radio frequency transmit signal of each of the transmitters 203A-N passes through the duplexer 214 to the respective antenna 215A-B such that the radio frequency transmit signal is transmitted by the transceiver system 201.

In the example of FIG. 2, a source of PIM 206 creating an air induced PIM is depicted. After being output, the radio frequency transmit signals pass through or impinge upon the source of PIM 206.

Due to the non-linearity of the source of PIM, the PIM may be introduced into a radio frequency receive signal received at the antennas 215A-B. The PIM may comprise IM products of the radio frequency transmit signals. The IM products include 3rd order IM products, fifth order IM products, etc.

The receiver 210 may, for example, include receiver components such as a low-noise amplifier (LNA), filters, a down-conversion circuitry, an analog-to-digital converter, and the like. The receiver 210 operates to process (e.g., amplify, filter, down-convert, and analog-to-digital convert) a radio frequency receive signal received from the antennas 215A-B via the duplexer 214 to output a digital output signal 220, which is referred to herein as a main receiver output signal 220.

The IM products of the radio frequency transmit signals produced by the source of PIM that fall within a passband of the receiver 210 result in a PIM distortion in the main receiver output signal 220 that is output by the receiver 210.

An estimate of the PIM distortion, which is a digital signal referred to herein as a PIM correction signal or interference signal, is generated and provided to subtraction circuitry 211. The subtraction circuitry 211 operates to subtract the PIM correction signal from the main receiver output signal 220 in the digital domain to provide a corrected output signal 221 which is referred to as an IM cleaned Rx main signal 221. The PIM correction signal is generated such that the PIM distortion in the corrected output signal is minimized, or at least substantially reduced, as compared to the PIM distortion in the main receiver output signal 220.

The PIM correction signal is generated by an apparatus 230. The apparatus 230 may be part of the transceiver system 201 e.g. the apparatus 230 may be integrated in an antenna system of the transceiver system 201. Being part of the transceiver system 201 may enable an individual adaptation of the apparatus for different transceiver systems. In another example, the apparatus 230 may not be part of the transceiver system 201. This may enable a centralized and thus consistent control of PIM effects among different transceiver systems. This may also enable to consider inter-site PIM effects. In case of a MIMO system, the apparatus may enable a generic MIMO PIM cancellation, in accordance with the present subject matter, for FDD systems.

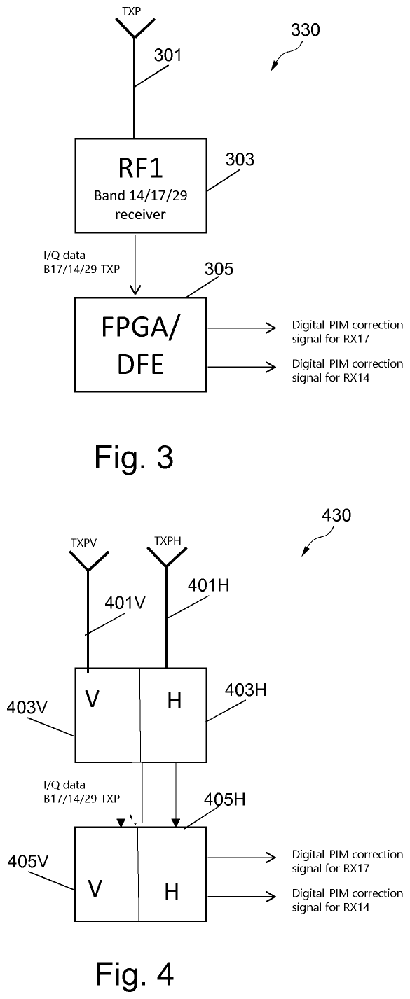

The apparatus 230 is configured to receive the main receiver output signal 220. The apparatus 230 is configured to receive radio frequency transmit signals transmitted through the air by transmitters of the transmitters 203A-N. The apparatus 230 is configured to estimate the PIM correction signal in accordance with the present subject matter. The apparatus 230 may be configured to provide the estimated PIM correction signal to the transceiver system 201. In case of multiple transceiver systems, the apparatus 230 may be configured to estimate the PIM correction signal for the receiver of each of the transceiver systems and to provide the estimated PIM correction signals to respective transceiver systems. FIGS. 3-4 provide examples of the apparatus 230.

FIG. 3 depicts a block diagram of an apparatus 330 in accordance with an example of the present subject matter.

The apparatus 330 comprises receiving means. The receiving means comprises an antenna 301 and a receiver 303 to which the antenna 301 is connected. The antenna 301 may be a receiving antenna, RX antenna. The antenna 301 is configured to match the same polarization of at least part of the antennas 215A-B in order to receive signals from the transmitters 203A-N.

The choice of antenna polarization of the antenna 301 may enable that transmit and receive antennas are paired by a matched polarization type. A vertically polarized transmit antenna works best with another vertically polarized receive antenna, and circularly polarized transmit antennas will work best with other circularly polarized receive antennas. Having a matched type polarization may prevent a polarization mismatch and a resulting loss of gain.

The receiver 303 may be configured to operate in different TX bands. The TX bands are at least part of the TX bands of the transmitters 203A-N. As exemplified in FIG. 3, the TX bands may comprise long LTE bands 14, 17 and 29 which may be the Tx bands of the transmitters 203A-N. The receiver 303 operates to process (e.g., amplify, filter, down-convert, and analog-to-digital convert) a radio frequency receive signal received from the antenna 301 to output a digital output signal to an estimation circuitry 305. For that, the receiver 303 may, for example, include receiver components such as a bandpass filter, low-noise amplifier (LNA), an analog-to-digital converter, and the like. The bandpass filter may be configured to filter the TX bands.

The apparatus 330 further comprises the estimation circuitry 305. The estimation circuitry 305 is connected to the receiver 303. The estimation circuit 305 is configured to estimate PIM correction signals based on captured signals at the antenna 301. As indicated in FIG. 3, the estimation circuitry 305 may estimate PIM correction signals for different receivers of the transceivers system operating at different frequency bands. The estimation circuitry 305 may be provided using field programmable gate arrays (FPGA) or application-specific integrated circuit (ASIC) implementation.

FIG. 4 depicts a block diagram of an apparatus 430 in accordance with an example of the present subject matter.

The apparatus 430 comprises receiving means. The receiving means comprises two antennas 401H, 4301V and two respective receivers 403H and 403V to which the antennas 401H and 401V is connected. The antennas 401H and 401V comprise a vertical (V) polarized antenna and a horizontal (H) polarized antenna.

The apparatus 430 further comprises an estimation circuitry 405H and 405V per receiver 403H and 403V respectively. The estimation circuitries 405H and 405V are connected to respective receivers 403H and 403V respectively. Each of the estimation circuitries 405H and 405V is configured to align and combine the received signals in accordance with the present subject matter in order to generate a composite signal. One of the two estimation circuitries 405H and 405V may perform an estimation of the PIM correction signal using the two composite signals.

As used in this application, the term “circuitry” may refer to one or more or all of the following:
a) hardware-only circuit implementations (such as implementations in only analog and/or digital circuitry) and
b) combinations of hardware circuits and software, such as (as applicable):
   I. a combination of analog and/or digital hardware circuit(s) with software/firmware and
   II. any portions of hardware processor(s) with software (including digital signal processor(s)), software, and memory(ies) that work together to cause an apparatus, such as a mobile phone or server, to perform various functions) and
c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

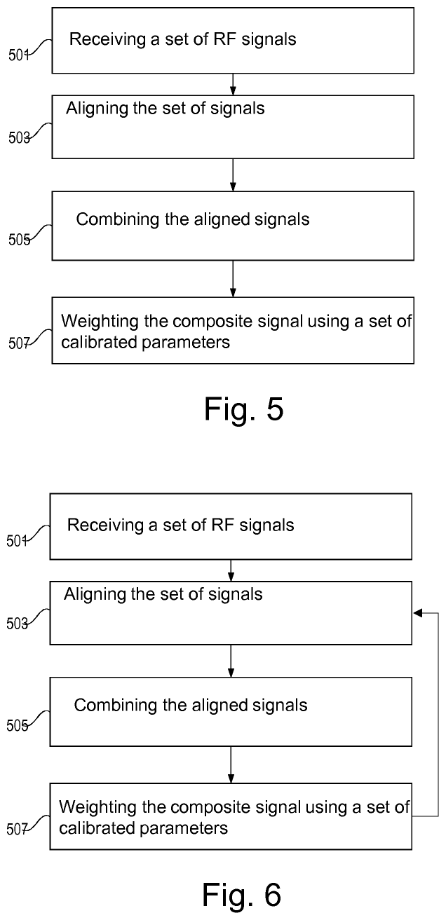

FIG. 5 is a flowchart of a method for estimating a PIM correction signal in accordance with an example of the present subject matter. For the purpose of explanation, the method may be implemented in the system illustrated in previous FIGS. 1-4, but is not limited to this implementation. For example, the method may be performed using the apparatus 330. The PIM correction signal may, for example, be estimated for a specific PIM issue e.g. involving a 3rd order IM product only. The PIM issue may be described by a model of PIM signals, wherein the calibrated parameters are parameters of the model.

A set of radio frequency transmit signals RF Tx1 . . . RF Txn may be received at the apparatus 330 in step 501. The radio frequency transmit signals RF Tx1 . . . RF Txn may for example be over-the-air signals received, in step 501, over the air from transmitters of the transmitters 203A-N. The set of RF transmit signals may be captured with dedicated antennas e.g. the antenna 301 of the apparatus may capture the set of RF transmit signals. Each RF signal of the set of RF transmit signals may be part of a stream having frequencies belonging to a respective frequency band e.g. each of the set of RF transmit signals may be a MIMO stream.

The received signals at the apparatus may have frequencies that belong to frequency bands that are supported by the apparatus 330. The apparatus 330 may for example receive several signals, wherein the set of RF transmit signals RF Tx1 . . . RF Txn may be selected from the several signals. The apparatus 330 may select the set of RF signals RF Tx1 . . . RF Txn on the basis of their frequencies e.g. using the band pass filter. In addition, the apparatus 330 may, for example, perform a selection on the basis of a determination of which signal frequencies of the filtered received several signals may produce IM products that may fall within a channel of the receiver 210. The determination may be performed using the relationships between signal frequencies and the frequencies of IM products produced from those frequencies. On the basis of this determination, the set of signals RF Tx1 . . . RF Txn may be selected.

The received RF transmits signals may further be processed by the receiver 303 of the apparatus 330 to provide respective digital output signals. This may result in received digital output signals S1 . . . Sn. E.g. Si (i=1 . . . n) may be a stream of signals having frequencies belonging to a respective frequency band i. That is, the received RF Tx signals may be output as digital signals S1 . . . Sn by the receiver 303 of the apparatus 330.

The set of digital output signal S1 . . . Sn may be processed by an estimation method comprising steps 503 to 507 in order to estimate an interference signal caused by the set of signals.

The set of digital output signals S1 . . . Sn may be aligned, in step 503, using delays between the set of signals S1 . . . Sn and a received signal Rx 220 at a selected receiver e.g. 210 of the communication system 200. The aligning may for example be performed by the estimation circuitry 305.

In one example, the delays may be computed at run time e.g. while the communication system is used for real data transmission. For example, each individual signal of the set of signals S1 . . . Sn may be correlated with the received signal Rx 220 to produce correlation data representing a correlation for each individual signal. The correlation may for example be a cross correlation. The correlation data may be used to define the delays. The cross-correlation may reach its maximum when the two correlated signals e.g. S1 and Rx considered become most similar to each other. The correlation data may comprise multiple values. Each delay of the delays may for example be determined using the maximum value of the correlation data. For example, the delay of signal S1 may be determined using the maximum value of the correlation data that is obtained by cross correlating S1 and Rx.

The correlation may, for example, be obtained by a cross-correlation function (xcorr) that has two arguments, wherein one of the arguments is the received signal Rx and the other argument can be a signal S1 . . . Sn. For example, the correlation may be obtained as a xcorr(abs(S1),abs(RX)). The result of the xcorr function is a vector. The delay of the signal S1 may be obtained using the maximum value of the vector.

In another example, the delays may be predefined. For example, the delays may be obtained during the calibration process as described herein. In another example, the delays obtained at run time may be compared with the respective delays obtained in the calibration process before being used. The delays obtained from the calibration process may be used as an upper bound or lower bound of the delays obtained at real time e.g. if the delay computed at real time exceeds the upper bound, the delay of the calibration process may be used instead for the aligning.

The aligned signals that result from step 503 are combined (e.g. by the estimation circuitry 305) in step 505 in order to generate a composite signal St. Combining the weighted signals may comprise performing the sum of the aligned signals.

The obtained composite signal St may be weighted (e.g. by the estimation circuitry 305) in step 507 using one or more calibrated parameters. Step 507 may further comprise providing or outputting the weighted composite signal. The weighting may be performed so that TX signals causing the PIM are combined in such a nonlinear fashion that they meet in time and frequency the received distortions and can be subtracted from digital receiver data. The weighted composite signal may be an estimation of an interference signal that is caused by the set of signals RF Tx1 . . . RF Txn at the receiver 210.

The weighting of the composite signal may for example be performed by modifying a characteristic of the composite signal. The characteristic of the composite signal may be at least one of a gain and phase of the signal. The modification may, for example, be performed via one or more complex coefficients An (which are the calibrated parameters). The weighting may be performed by a multiplication as follows An*St.

In another example, the weighting of the composite signal may be performed using a linear filter comprising taps of complex parameters, so that the composite signal may be filtered with an k tap filter. In this case, the weighting may involve a convolution operation as follows: conv(Ak*St), where Ak is a vector with n*k tap complex filter coefficients which are the calibrated parameters.

The estimated interference signal may be a PIM correction signal which may, for example, be used for test purpose to accurately quantify the PIM issue and measure PIM impact in the communication system 200. In another example, the PIM correction signal may be used to correct the main receiver output signal 220.

FIG. 6 is a flowchart of a of a method for estimating multiple PIM correction signals in accordance with an example of the present subject matter. The method of FIG. 6 may enable to estimate the PIM correction signals for multiple receivers e.g. L receives. The method of FIG. 6 may comprise repeating the method of FIG. 5 L times, wherein in each iteration a PIM signal is estimated for a given receiver of the L receivers. The repeated execution of steps 503-507 may for example be performed in parallel. This may save processing time of the present subject matter. The execution of step 507 in each iteration may use a different set of calibrated parameters that is obtained for the respective receiver.

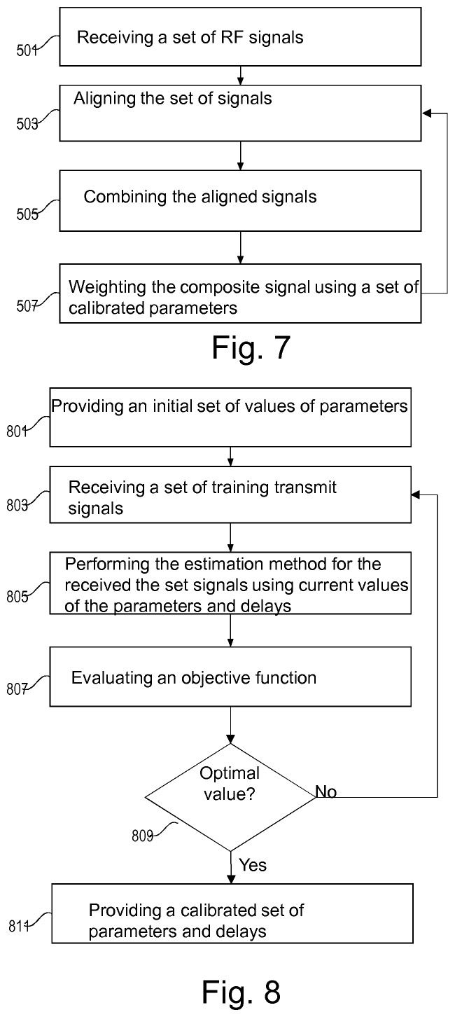

FIG. 7 is a flowchart of a method for estimating multiple PIM correction signals in accordance with an example of the present subject matter. The method of FIG. 7 may enable to estimate the PIM correction signals for multiple sources of PIMs e.g. G sources of PIMs. The method of FIG. 7 may comprise repeating the method of FIG. 5 G times, wherein in each iteration a PIM signal is estimated for a source of PIM of the G sources of PIMs. The repeated execution of steps 503-507 may for example be performed in parallel. This may save processing time of the present subject matter. Each delay of the delays of step 503 may be obtained in each iteration using the correlation data as described herein. For example, in a first iteration of the method, the delay may be the maximum value in the correlation data. In a second iteration the delay may be the second maximum value of the correlation data etc.

FIG. 8 is a flowchart of a method for obtaining optimal values of a set of PIM model parameters and delays. FIG. 8 describes an example of the calibration process in accordance with the present subject matter.

In step 801, an initial set of values of the PIM model parameters may be provided. The initial set of values are the current values of the PIM model parameters. In addition, initial values of delays are provided e.g. a delay value may be provided for each frequency band of the transmit frequency bands of the transmitters. For example, the estimation circuitry 305 may be configured to operate with (or use) those current values of the PIM model parameters and delays in step 801.

In step 803, a set of training transmit signals may be received at the estimation circuitry 305. The set of training transmit signals are uncorrelated signals, and each signal of the set of training transmit signals has all resource blocks being used for a maximum bandwidth usage and power. In one example, the set of training transmit signals may be real signals that are received at run time. That is, the calibration process may be performed at run time of the apparatus 230.

The estimation method may be performed in step 805 on the received set of training transmit signals to estimate a PIM correction signal using the current values of the PIM model parameters and the delays.

An objective function may be evaluated in step 807. The objective function relates a received training receive signal at the receiver 210 with a corrected signal that is obtained by correcting the received training receive signal by the interference signal caused by the set of training transmit signals. The objective function may for example be the following cost function, gain=10log(RMS(RXb)/RMS(RXa)), where Rb is a signal received at the receiver, Rxa is a corrected signal that results from the subtraction of the interference signal from Rxb, and RMS refers to a root mean square power calculation. In another example, a receiver total wideband power (RTWP) method may be used in the cost function instead of RMS. The optimization of the cost function may for example be performed using the “Nelder Mead” method or a gradient based method. The gradient based method may have a better conversion speed.

It may be determined (inquiry step 809) whether an optimal value of the objective function is obtained. The optimal value indicates an improvement in the performance of the estimation of the PIM signal by the apparatus. The optimal value of the objective function may be a maximum value of the cost function. If not, the current values of the calibrated set of parameters and the delays may be modified. The modified values become the current values of the PIM model parameters and the delays for a next iteration of steps 803-809.

If it is determined that an optimal value of the objective function is obtained, the current values of the PIM model parameters are values of the calibrated set of parameters. The calibrated set of parameters and the current values of delays may be used e.g. in methods of FIGS. 5-7 in order to estimate PIM signals at run time. And the calibrated set of parameters and the delays may be provided in step 811.

Steps 801, 807, 809 and 811 may be performed by an optimizer and steps 803-805 may be performed by the apparatus 230. The optimizer may for example be part of the apparatus e.g. 230.

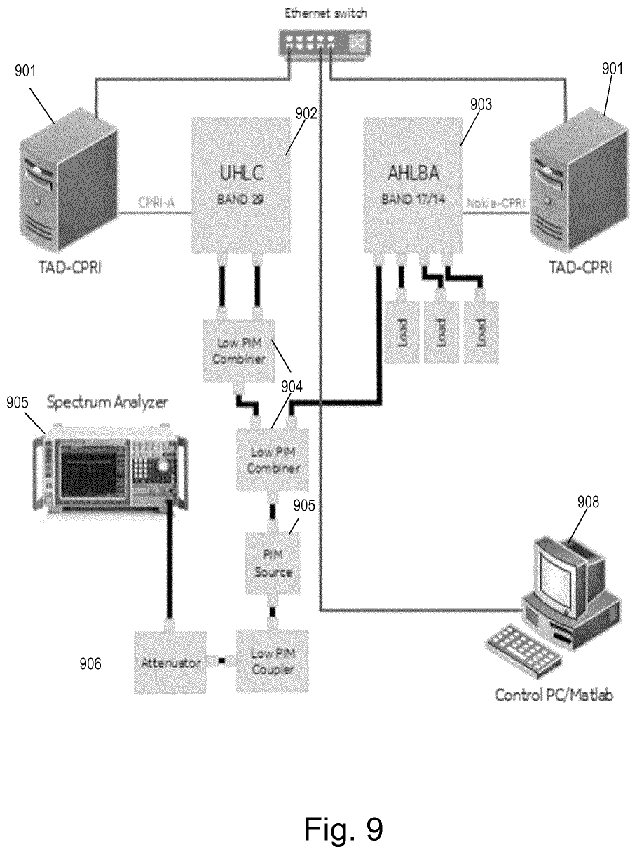

FIG. 9 is a block diagram of a calibration setup for obtaining values of the calibrated parameters. The calibration setup may for example be used to perform the calibration process. The calibration setup 900 mimics a communication system such as the communication system of FIG. 2. The calibration setup is depicted with real radios in an air induced PIM environment.

Devices 901 provide an emulation of a system module or base band unit (BBU). UHLC and AHLBA are radio names for radio transmitters 902 and 903 respectively. The devices 901 and radio transmitters 902-903 enable to transmit a set of training signals in multiple transmit frequency bands. The setup 900 provides data paths of the signals so that the signals transmitted by the radio transmitters 902 and 903 hit a PIM source 905 and a PIM signal is generated. For example, the set of training signals may be combined using combiners 904 before hitting the PIM source 905 of the calibration setup 900. The combiners 904 enable to combine or generate a stream of signals for each frequency band to mimic a MIMO stream per frequency band.

The generated composite signal of the signals of the transmitters 902 and 903 may be pre-processed before being analyzed and captured by a spectrum analyzer 907. The spectrum analyzer 907 may provide (e.g. display) the composite signal. For example, an attenuation of the signal power may be performed by the attenuator 906. The setup 900 is configured so that it enables to a PC controller 908 access to all individual TX data, composite TX signal and RX channels with the PIM noise so that the calibration process may be performed.

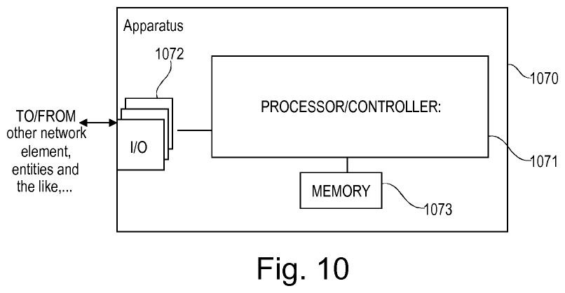

In FIG. 10, a block circuit diagram illustrating a configuration of an apparatus 1070 is shown, which is configured to implement at least part of the present subject matter. It is to be noted that the apparatus 1070 shown in FIG. 10 may comprise several further elements or functions besides those described herein below, which are omitted herein for the sake of simplicity as they are not essential for the understanding. Furthermore, the apparatus may be also another device having a similar function, such as a chipset, a chip, a module etc., which can also be part of an apparatus or attached as a separate element to the apparatus, or the like. The apparatus 1070 may comprise a processing function or processor 1071, such as a CPU or the like, which executes instructions given by programs or the like related to a flow control mechanism. The processor 1071 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 1072 denotes transceiver or input/output (I/O) units (interfaces) connected to the processor 1071. The I/O units 1072 may be used for communicating with one or more other network elements, entities, terminals or the like. The I/O units 1072 may be a combined unit comprising communication equipment towards several network elements, or may comprise a distributed structure with a plurality of different interfaces for different network elements. Reference sign 1073 denotes a memory usable, for example, for storing data and programs to be executed by the processor 1071 and/or as a working storage of the processor 1071.

The processor 1071 is configured to execute processing related to the above described subject matter. In particular, the apparatus 1070 may be configured to perform at least part of the method as described in connection with FIGS. 5-8.

The processor 1071 is configured to align in time a set of captured on-the-air signals using delays between the set of signals and a received signal at a selected receiver of the communication system; combine the set of aligned signals to generate a composite signal; estimate an interference signal that is caused by the set of signals at the selected receiver by weighting the composite signal using a set of one or more calibrated parameters.

1. An apparatus for a communication system, the communication system comprising transmitters being configured to operate in multiple transmission frequency bands, the apparatus comprising:
at least one processor; and
at least one memory including computer program code, the at least one memory and computer program code being configured, with the at least one processor, to cause the apparatus to perform:
capturing a set of over-the-air signals at distinct frequency bands of the multiple transmission frequency bands;
aligning in time the set of signals using delays between the set of signals and a received signal at a selected receiver of the communication system; and
combining the set of aligned signals to generate a composite signal;
estimating an interference signal that is caused by the set of signals at the selected receiver by weighting the composite signal using a set of one or more calibrated parameters for the estimation.

2. The apparatus of claim 1, further comprising an antenna system which, in conjunction with the at least one memory, computer program code, and the at least one processor, performs the capturing, the antenna system being configured to be polarized in accordance with polarizations of the transmitters.

3. The apparatus of claim 2, the antenna system comprising a first antenna being polarized in accordance with a first polarization direction for capturing a subset of signals of the set of signals having the first polarization direction, and a second antenna being polarized in accordance with a second polarization direction for capturing a subset of signals of the set of signals having the second polarization direction.

4. The apparatus of claim 3, wherein the antenna system comprises a receiver per antenna of the antenna system.

5. The apparatus of claim 1, the set of signals comprising inter-band and intra-band signals, wherein the at least one memory and computer program code are further configured, with the at least one processor, to cause the apparatus to determine one same delay for intra-band signals of a same frequency band.

6. The apparatus of claim 1, wherein the at least one memory and computer program code are further configured, with the at least one processor, to cause the apparatus to perform a cross correlation of each signal of the set of signals with the received signal; and to determine the delays using results of the cross correlation.

7. The apparatus of claim 6, the cross correlation being performed between absolute values of the signal and absolute values of the received signal.

8. The apparatus of claim 1, wherein the at least one memory and computer program code are further configured, with the at least one processor, to cause the apparatus to perform:
further aligning in time the set of signals using further delays of the set of signals to the selected receiver;
combining the further aligned set of signals to generate a further composite signal;
weighting the further composite signal using another set of one or more calibrated parameters, thereby estimating another interference signal that is caused by the set of signals at the selected receiver, the other interference signal having a frequency different from a frequency of the interference signal.

9. The apparatus of claim 8, wherein the at least one memory and computer program code are further configured, with the at least one processor, to cause the apparatus to perform a cross correlation of each signal of the set of signals with a received signal at the selected receiver; and
determining the delay of the signal using a maximum value of the resulting cross correlation and determining the other delay of the signal using a second maximum value of the resulting cross correlation.

10. The apparatus of claim 1, the calibrated parameters being parameters of a pulse intermodulation, PIM, model, wherein the at least one memory and computer program code are further configured, with the at least one processor to cause the apparatus to perform determining, during a calibration step, values of the calibrated parameters in accordance with a system configuration of the communication system, the determining comprising comparing estimated interference signals with calibration interference signals.

11. The apparatus of claim 10, the system configuration indicating at least one or more sources of a passive intermodulation, PIM.

12. The apparatus of claim 1, wherein the at least one memory and computer program code are further configured, with the at least one processor, to cause the apparatus to correct a received signal at the selected receiver by using the interference signal.

13. The apparatus of claim 12, wherein the at least one memory and computer program code are further configured, with the at least one processor, to cause the apparatus to correct the signal by a subtraction processing of the interference signal from the received signal being.

14. The apparatus of claim 1, wherein the apparatus comprises a frequency division duplex base transceiver station.

15. (canceled)

16. A method for a communication system, comprising:
capturing a set of over-the-air signals at distinct transmission frequency bands of the communication system;
aligning in time the set of signals using delays between the set of signals and a received signal at a selected receiver of the communication system;
combining the set of aligned signals to generate a composite signal;
estimating an interference signal that is caused by the set of signals at the selected receiver by weighting the composite signal using a set of one or more calibrated parameters.

17. The method of claim 16, further comprising repeating the aligning, combining and weighting for another selected receiver of the communication system, thereby estimating an interference signal that is caused by the set of signals at the other selected receiver.

18. The method of claim 16, further comprising repeating the aligning, combining and weighting steps using for the aligning further delays of the set of signals to the selected receiver and using a set of further calibrated parameters for the weighting.

19. A computer program embodied on a non-transitory computer-readable medium, said computer program comprising instructions stored thereon for performing at least:
aligning in time a set of captured on-the-air signals using delays between the set of signals and a received signal at a selected receiver of a communication system;
combining the set of aligned signals to generate a composite signal;
estimating an interference signal that is caused by the set of signals at the selected receiver by weighting the composite signal using a set of one or more calibrated parameters.
